(19) United States
(12) Patent Application Publication
(10) Pub. No.: US 2009/0305023 A1
(43) Pub. Date: Dec. 10, 2009

(54) Preparation of Porous Carbon Materials Using Agricultural Wastes

(75) Inventors: Shui-Tein Chen, Taipei (TW); Shih-Hsiung Wu, Taipei (TW); Jung-Feng Hsieh, Taipei (TW); Bay-ming Ou, Taipei (TW); Min-Hsuan Chang, Taipei (TW); Tsung-Ling Fang, Taipei (TW); Wei-Ying Hseih, Taipei (TW)

Correspondence Address: OCCHIUTI ROHLICEK & TSAO, LLP, 10 FAWCETT STREET, CAMBRIDGE, MA, 02138, US

(73) Assignee: Academia Sinica, Taipei (TW)

(21) Appl. No.: 12/428,560

(22) Filed: Apr. 23, 2009

Related U.S. Application Data
(60) Provisional application No. 61/047,847, filed on Apr. 25, 2008.

(51) Int. Cl. B32B 3/26; C10B 57/04; C10B 57/06

(52) U.S. Cl. 428/304.4; 201/25; 201/20

(57) ABSTRACT

A method of preparing porous carbon materials using agriculture wastes derived from plants.

### RELATED APPLICATION

This application claims priority to U.S. Provisional Application No. 61/047,847, filed on Apr. 25, 2008, the content of which is hereby incorporated by reference in its entirety.

### BACKGROUND OF THE INVENTION

Agricultural wastes, e.g., rice straw and hulls, wheat leaves, corn straw and cobs, bagasse, almond shells, and grape seeds, are usually decomposed by burning, which produces ash residues used as inorganic fertilizers. The burning process, however, generates a lot of smoke and suspended particles, both of which are detrimental, i.e., causing air pollution and respiratory diseases. Thus, there is a need to develop a new method of decomposing and utilizing agriculture wastes.

### SUMMARY OF THE INVENTION

One aspect of the present invention is a method of preparing a porous carbon material by (1) providing a dry carbon-containing agricultural waste derived from a plant (e.g., rice straw, wheat straw, corn straw, bagasse, almond shell, grape seed, rice hull, and corn cob), (2) subjecting the waste to a first round of pyrolysis, which includes heating the waste at 400-500° C. (e.g, 450° C.) for 1-3 hours (e.g., 2 hours) in the absence of oxygen, (3) soaking the pyrolyzed waste in an alkaline solution (e.g., KOH), and subjecting the soaked waste to a second round of pyrolysis, which includes heating the soaked waste at 800-900° C. (e.g., 850° C.) for 2-4 hours (e.g., 3 hours) in the absence of oxygen to produce the porous carbon material.

The first round of pyrolysis can be performed by conducting the following steps sequentially: (i) heating the waste at 130° C. for 2 hours, wherein the heating temperature is increased from room temperature to 130° C. at a rate of 5° C. per minute, (ii) heating the waste at 280° C. for 2 hours, wherein the heating temperature is increased from 130° C. to 280° C. at a rate of 10° C., and (iii) heating the waste at 450° C. for 2 hours, wherein the heating temperature is increased from 280° C. to 450° C. at a rate of 10° C. per minute.

The second round of pyrolysis can be performed by conducting the following steps sequentially: (i) heating the soaked waste at 130° C. for 2 hours, wherein the heating temperature is increased from room temperature to 130° C. at a rate of 5° C. per minute, (ii) heating the soaked waste at 280° C. for 2 hours, wherein the heating temperature is increased from 130° C. to 280° C. at a rate of 10° C., (iii) heating the soaked waste at 450° C. for 2 hours, wherein the heating temperature is increased from 280° C. to 450° C. at a rate of 10° C. per minute; and (iv) heating the soaked waste at 850° C. for 3 hours, wherein the heating temperature is increased from 450° C. to 850° C. at a rate of 10° C. per minute.

In another aspect, this invention provides a porous carbon material having a BET surface area of 900-1100 m²/g (e.g., 1034 m²/g) and an average BET pore diameter of 20-25 Å (24 Å). This porous carbon material can be prepared by the method of this invention.

Also within the scope of this invention is a method of adsorbing a substance by contacting the substance with the porous carbon material described above.

The details of one or more embodiments of the invention are set forth in the description below. Other features or advantages of the present invention will be apparent from the following drawings and detailed description of several embodiments, and also from the appending claims.

### BRIEF DESCRIPTION OF THE DRAWINGS

The drawings are first described.

FIG. 1 is a flowchart showing a 7-step process of preparing a porous carbon material from rice straw. Steps 1 and 2 are carbonating steps for making a carbon-liked material using rice straw. Steps 3 to 6 are activating steps for making the carbon-like material porous.

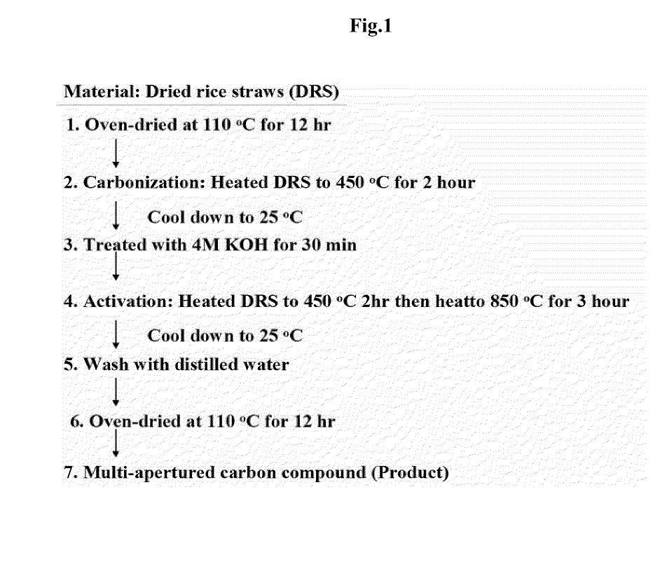

FIG. 2 is a number of scanning electronic micrographs of rice straw and the porous carbon material prepared from rice straw.

FIG. 3 is a diagram showing the capacity of the porous carbon material described herein for adsorbing methylene blue.

FIG. 4 is a diagram showing the capacity of the porous carbon material described herein for adsorbing iodine.

### DETAILED DESCRIPTION OF THE INVENTION

Described herein is a method of preparing a porous carbon material from an agricultural waste derived from a plant, which refers to residues produced in the process of preparing an agriculture plant product.

This method includes two rounds of pyrolysis separated by a chemical activation step. Before the first round of pyrolysis, a plant agriculture waste (e.g., rice straw) is dried and cut into pieces having a suitable size. The dried waste pieces then undergo the first round of pyrolysis by being heated at 400-500° C. for 1 to 3 hours in the absence of oxygen. Preferably, this round of pyrolysis is carried out as follows. The dried waste is kept in an oven, the temperature in which is increased from room temperature to 120-150° C. at a rate of about 5° C. per minute. After the temperature reaches 120-150° C., the waste is kept in the over for 2 hours. Then the temperature in the over increases to 260-300° C. at a rate of 10° C. per minute and the waste is heated at this temperature for 2 hours. Finally, the temperature in the oven increases from 260-300° C. to 400-500° C. also at a rate of 10° C. and the waste is then heated for 1 to 3 hours, preferably 2 hours. During this pyrolysis process, the dried agriculture waste turns into a carbon material.

After the first round of pyrolysis, the carbon material is cooled for a suitable period of time (e.g., overnight) and then subjected to chemical activation by being soaked in an alkaline solution, i.e., a solution having a pH value of at least 10, which is preferably KOH or NaOH. This chemical activation process allows pore formation on the surface of the carbon material.

Next, the carbon material undergoes the second round of pyrolysis by being heated at 800-900° C. for 2-4 hours, preferably for 3 hours. In one example, this round of pyrolysis is carried out in a manner similar to the first round of pyrolysis described above, except that after heating the carbon material at 400-500° C. for 1-3 hours, the heating temperature is elevated to 800-900° C. at a rate of 10° C. per minute and the carbon material is heated at this temperature for 2-4 hours. A porous carbon material is formed after the just-described second round of pyrolysis.

The porous carbon material formed by the method described above has a large surface area (i.e., 900-1100 m²/g) and an average pore size of 20-25 Å (determined by BET) or an average pore size of 45-55 Å (determined by BJH adsorption). It can be used for water purification (e.g., for home aquariums), wastewater treatment, or gas purification. It also can be used in making medicine or filters.

Without further elaboration, it is believed that one skilled in the art can, based on the above description, utilize the present invention to its fullest extent. The following specific embodiments are, therefore, to be construed as merely illustrative, and not limitative of the remainder of the disclosure in any way whatsoever.

### Example 1

### Preparation of a Porous Carbon Material from Rice Straw

Rice straw was dried in an oven at 110° C. for 12 h, cut into 3-4 cm pieces, and underwent a first round of pyrolysis to produce a carbon material. The conditions of this pyrolysis process are shown in Table 1 below:

TABLE 1
Conditions of the first round of pyrolysis:

| Temperature (° C.) | Hold time (hr) | Heating Rate (min⁻¹) |
|---|---|---|
| room temperature −> 130 | 2 | 5° C. |
| 130 −> 280 | 2 | 10° C. |
| 280 −> 450 | 2 | 10° C. |

After being cooled overnight, the carbon material was subjected to chemical activation by being soaked in 4M KOH (2 fold by weight versus the carbon material) for 30 minutes. The soaked carbon material was then dried in an oven at 110° C. for 12 hrs and subjected to a second round of pyrolysis to produce a porous carbon material. The conditions of this pyrolysis process are shown in Table 2 below,

TABLE 2
Conditions of The Second Round of Pyrolysis

| Temperature (° C.) | Hold time (hr) | heating rate (min⁻¹) |
|---|---|---|
| room temperature −> 130 | 2 | 5° C. |
| 130 −> 280 | 2 | 10° C. |
| 280 −> 450 | 2 | 10° C. |
| 450 −> 850 | 3 | 10° C. |

The porous carbon material thus produced was cooled to room temperature, washed by double-distilled water to remove remaining KOH, and dried again in an oven at 110° C. for 12 h.

The pore size distribution, BET surface area, and micropore volume Vₘₑₛₒ of the porous carbon material were determined from an N₂ adsorption experiment, applying the conventional Barrett-Joyner-Halenda (BJH) and Langmuir methods or using a Surface Area and Pore Size Analyzer (BET, ASAP 2010, Micromeritics Co., Georgia, USA, at 77K). Briefly, the porous carbon material was first degassed at 100° C. and then subjected to the N₂ adsorption analysis using a computer to monitor the adsorbed nitrogen volume; volume and various equilibrium pressure and BET surface area of the material were reported. The results thus obtained are shown in Table 3 below.

TABLE 3
Surface Area and Average Pore Size of The
Porous Carbon Material (N₂ adsorption)

| | | | | Average Pore |
|---|---|---|---|---|
| | Surface Area | | Average Pore | Diameter (Å) |
| | (m2/g) By | BET | Diameter (Å) | By BJH |
| | Langmuir | Surface | By BET | Adsorption |
| Porous | 1394.7216 | 1034.8405 | 23.9221 | 51.5506 |
| Carbon | | | | |
| Material | | | | |

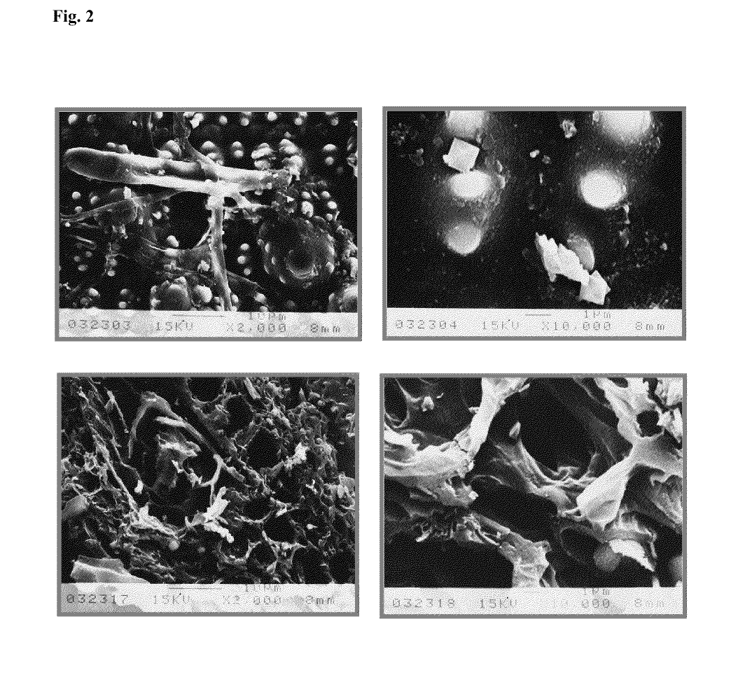

The surface morphology of the porous carbon material was examined under a scanning electronic microscope and the results thus obtained are shown in FIG. 2.

### Example 2

### Capacity of the Porous Carbon Material for Adsorbing Methylene Blue

Methylene Blue was dissolved in double-distilled water to prepare a methylene blue solution (0.12%; 1200 ppm), which was then serially diluted to obtain solutions having five different concentrations. The adsorption values (Y value) of the solutions were determined by a spectrophotometer at 658 nm. A calibration curve was produced based on the results thus obtained.

In a test sample, 0.1 g of the porous carbon material was dispersed in 20 ml of a methylene blue solution (0.12%) and shaken at 75 rpm, 25° C. for 30 minutes. Two control samples, containing two commercially available carbon materials (from Norit and Sigma) were prepared following the procedure described above. A methylene blue solution (0.12%) absent the carbon material was used as a blank control. The methylene blue solutions containing and not containing the carbon material were filtered, diluted to 50-100 folds, and then subjected to spectrophotometer examination to obtain their absorption value. The adsorption capacity of the porous carbon material is calculated as follows:

$$Adsorption Capacity = \frac{( C - M ) * V * 1000}{S}$$

C=conc. of control methylene blue (%);

M=conc. of methylene blue after active carbon adsorption (%);

V=volume of methylene blue (mL);

S=weight of active carbon.

C and M are obtained by determining the methylene blue concentrations corresponding to the adsorption values of the control sample and test sample according to the calibration curve mentioned above.

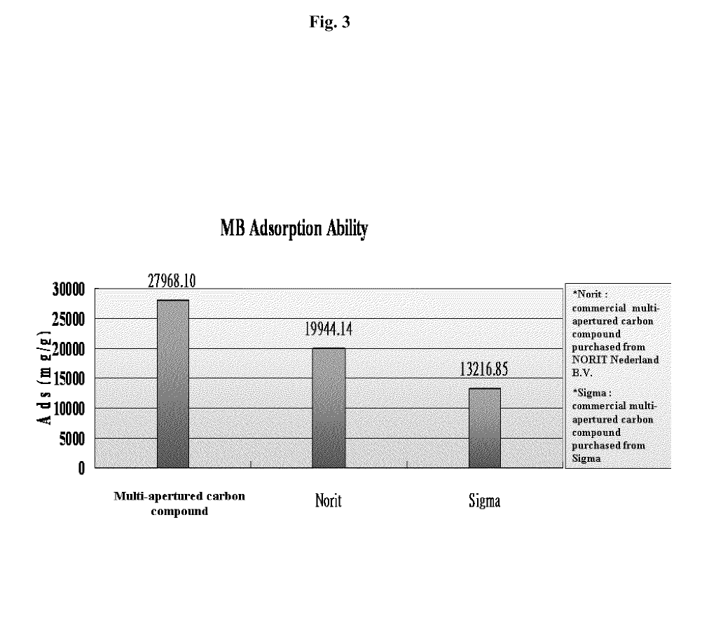

Results thus obtained are shown in FIG. 3. More specifically, the porous carbon material's ability to adsorb methylene blue 27968.10 mg/g; those of the control samples, i.e., Norit and Sigma, are 19944.14 mg/g, and 13216.85 mg/g, respectively.

### Example 3

### Capacity of the Porous Carbon Material for Adsorbing Iodine

0.1 g porous carbon material was mixed with an iodine solution (0.05M) to form a test sample. Norit and Sigma, two commercially available carbon materials, each were mixed with the same iodine solution to form two control samples. The iodine solution absence of any carbon material was used as a blank control.

The test sample and the two control samples were shaken at 75 rpm, 25° C. for 30 minutes and then filtered. A starch solution, used as an indicator, was prepared by dissolving 2 g starch in 30 ml water, diluted in 1 L boiled water, and heated until the resultant solution was clear. 2 to 3 drops of the starch solution were added to the test and control samples (10 ml of each), which was then titrated against a 0.1 M Na₂S₂O₃-5H₂O solution until the sample turned yellow. The concentrations of the remaining iodine after adsorption by the porous carbon material and the Norit/Sigma materials were calculated as follows:

2S₂O₃²⁻+I₂→S₄O₆²⁻+2I⁻

$$Iodine conc . = \frac{\begin{matrix}{Na}_{2} {SO}_{3} \cdot 5 {H}_{2} O conc . [ M ] * \\ {Na}_{2} {SO}_{3} \cdot 5 {H}_{2} O volume [ mL ]\end{matrix}}{2 * Iodine volume [ mL ]}$$

The capacities of the carbon materials for adsorbing iodine are calculated following the formula of:

$$Adsorption ability of active carbon = \frac{[ C - M ] * V ( l ) * 1000}{S ( g )}$$

C=conc. of control iodine solution (M);

M=conc. of iodine solution after active carbon adsorption (M);

V=volume of iodine solution;

S=weight of active carbon.

Molecular weight of Iodine=253.8 (g/mole)

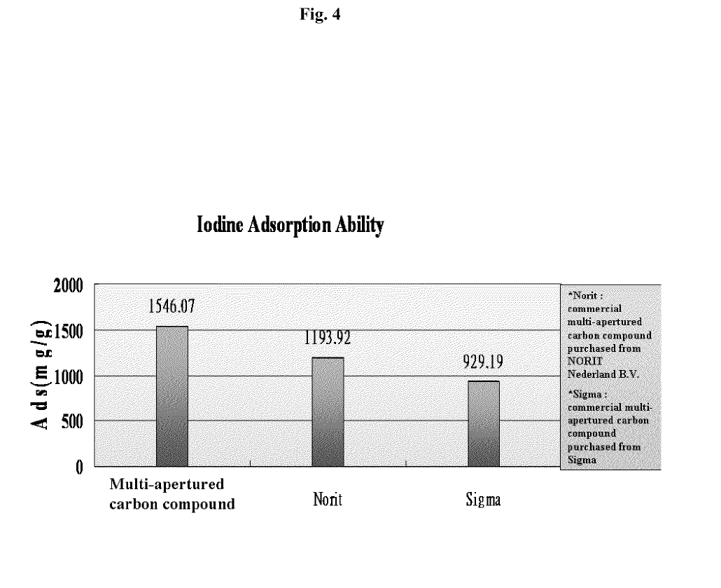

The results thus obtained are shown in FIG. 4. The iodine adsorption capacity of the porous carbon material (i.e., 1546.07 mg/g) is much higher than those of the Norit carbon material, and the Sigma carbon material (i.e., 1193.92 mg/g and 929.19 mg/g, respectively).

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A method of preparing a porous carbon material, comprising:
providing a dry carbon-containing agricultural waste derived from a plant,
subjecting the waste to a first round of pyrolysis, which includes heating the waste at 400-500° C. for 1-3 hours in the absence of oxygen,
soaking the pyrolyzed waste in an alkaline solution, and
subjecting the soaked waste to a second round of pyrolysis, which includes heating the soaked waste at 800-900° C. for 2-4 hours in the absence of oxygen to produce a porous carbon material.

2. The method of claim 1, wherein the first round of pyrolysis includes heating the waste at 450° C. for 2 hours.

3. The method of claim 2, wherein the second round of pyrolysis includes heating the soaked waste at 850° C. for 3 hours.

4. The method of claim 2, wherein the first round of pyrolysis is performed by conducting the following steps sequentially: (i) heating the waste at 130° C. for 2 hours, wherein the heating temperature is increased from room temperature to 130° C. at a rate of 5° C. per minute, (ii) heating the waste at 280° C. for 2 hours, wherein the heating temperature is increased from 130° C. to 280° C. at a rate of 10° C., and (iii) heating the waste at 450° C. for 2 hours, wherein the heating temperature is increased from 280° C. to 450° C. at a rate of 10° C. per minute.

5. The method of claim 4, wherein the second round of pyrolysis includes heating the soaked waste at 850° C. for 3 hours.

6. The method of claim 1, wherein the alkaline solution is KOH.

7. The method of claim 5, wherein the alkaline solution contains KOH.

8. The method of claim 1, wherein the second round of pyrolysis is performed by conducting the following steps sequentially: (i) heating the soaked waste at 130° C. for 2 hours, wherein the heating temperature is increased from room temperature to 130° C. at a rate of 5° C. per minute, (ii) heating the soaked waste at 280° C. for 2 hours, wherein the heating temperature is increased from 130° C. to 280° C. at a rate of 10° C., (iii) heating the soaked waste at 450° C. for 2 hours, wherein the heating temperature is increased from 280° C. to 450° C. at a rate of 10° C. per minute; and (iv) heating the soaked waste at 850° C. for 3 hours, wherein the heating temperature is increased from 450° C. to 850° C. at a rate of 10° C. per minute.

9. The method of claim 4, wherein the second round of pyrolysis is performed by conducting the following steps sequentially: (i) heating the soaked waste at 130° C. for 2 hours, wherein the heating temperature is increased from room temperature to 130° C. at a rate of 5° C. per minute, (ii) heating the soaked waste at 280° C. for 2 hours, wherein the heating temperature is increased from 130° C. to 280° C. at a rate of 10° C., (iii) heating the soaked waste at 450° C. for 2 hours, wherein the heating temperature is increased from 280° C. to 450° C. at a rate of 10° C. per minute; and (iv) heating the soaked waste at 850° C. for 3 hours, wherein the heating temperature is increased from 450° C. to 850° C. at a rate of 10° C. per minute.

10. The method of claim 9, wherein the alkaline solution contains KOH.

11. The method of claim 1, wherein the agriculture waste is selected from the group consisting of rice straw, wheat straw, corn straw, bagasse, almond shell, grape seed, rice hull, and corn cob.

12. The method of claim 9, wherein the agriculture waste is selected from the group consisting of rice straw, wheat straw, corn straw, bagasse, almond shell, grape seed, rice hull, and corn cob.

13. A porous carbon material, wherein the material has a BET surface area of 900-1100 m²/g and an average BET pore diameter of 20-25 Å.

14. A porous carbon material, wherein the porous carbon material is prepared by the method of claim 1.

15. A porous carbon material, wherein the porous carbon material is prepared by the method of claim 4.

16. A porous carbon material, wherein the porous carbon material is prepared by the method of claim 9.

17. A method of adsorbing a substance, comprising contacting the substance with a porous carbon material having a BET surface area of 900-1100 m²/g and an average BET pore diameter of 20-25 Å.

18. A method of adsorbing a substance, comprising contacting the substance with a porous carbon material prepared by the method of claim 1.

19. A method of adsorbing a substance, comprising contacting the substance with a porous carbon material prepared by the method of claim 4.

20. A method of adsorbing a substance, comprising contacting the substance with a porous carbon material prepared by the method of claim 9.
